(19) United States
(12) Patent Application Publication
(10) Pub. No.: US 2016/0155369 A1
(43) Pub. Date: Jun. 2, 2016

(54) FLAG APPARATUS

(71) Applicants: Hyun Phill, Seoul (KR); LT ELECTRONICS CO., LTD., Gyeonggi-do (KR)

(72) Inventors: Hyun Phill HONG, Gunpo-si, Gyeonggi-do (KR); Soon Kyo HONG, Gunpo-si, Gyeonggi-do (KR)

(21) Appl. No.: 14/905,628

(22) PCT Filed: Jul. 15, 2014
(86) PCT No.: PCT/KR2014/006367

§ 371 Date: Jan. 15, 2016

(30) Foreign Application Priority Data
Jul. 16, 2013 (KR) 10-2013-0083474
Jul. 15, 2014 (KR) 10-2014-0088950

(51) Int. Cl. G09F 17/00; F21S 9/03; F21V 23/02; F21V 8/00; F21V 23/00

(52) U.S. Cl. CPC G09F 17/00; G02B 6/001; F21V 23/003; F21V 23/02; F21S 9/032; F21S 9/035; F21W 2111/00

(57) ABSTRACT

The present invention relates to a flag apparatus having a letter or figure displayed thereon, which is formed through weaving or embroidery of an optical fiber and thus can be easily recognized even at nighttime. The flag apparatus includes a supporting pole, a flag suspended from the supporting pole, an optical fiber thread having an exposure part which is formed by exposing a partial area of the upper surface of the flag and is configured in a letter or figure, and a power source module for irradiating light or an image on the optical fiber thread, wherein the power source module includes a light source unit, a power supply unit for supplying electric power to the light source unit, and a control unit for controlling the light source unit and the power supply unit, and the exposure part is configured to be installed on the flag through at least one method among weaving, embroidery, sewing, laminating, and piping. Therefore, by the flag apparatus, a flag be placed on a ship or in a restaurant or a shop can be recognized even at nighttime.

### TECHNICAL FIELD

The present invention relates to a flag apparatus, more particularly, to a flag apparatus having a letter or figure displayed thereon, which is formed through weaving or embroidery of an optical fiber and thus can be easily recognized even at nighttime.

### BACKGROUND ART

In general, a flag is used in various fields as a national flag which is a symbol of a country, a hoist flag which is a symbol of a government office, a local autonomy, a school, a sport, or a troop, and a triangular flag used for promoting an event or representing a milestone, as well as a pennant, a condolence flag, a shoulder girdle, a ship identification flag, or a flag for a restaurant or a shop.

In detail, the national flag is hoisted on a house, a government office or a street lamp to raise patriotism during various memorial days such as national holydays. In addition, various flags that represent various local autonomies or used for various events or festivals may also be hoisted at the wayside of the local roads, at the wayside forwarding to the festival or event places, or around the event place to arouse the atmosphere of the festival or the event. Further, an information flag is used in a restaurant or a shop to show sorts of food or goods provided or any events in the restaurant or the shop.

In addition, the flag is installed at a ship as a naval ensign or a naval jack to represent a type or a country of a ship according to the size of the ship.

Further, the flag is used in a lake, a river or a sea as an indicative means, such as a lighthouse or a float (buoy). Among the indicative means, the float having various shapes is used for various purposes to alarm the dangerous area, such as a submerged rock or an underwater obstacle, to indicate a position of facilities, such as an underwater cable or an underwater facility, and to define the boundary of an aquaculture ground or a fishery tool such as a net. The float may include an anchor structure installed on a bottom of the sea, lake or river and a float member connected to the anchor structure through a chain or a rope, in which a single float member or a group of float members may be used and the float member may be combined with a supplement member, such as a flag, for desired purposes.

One example of technologies that use the flag is disclosed in Korean Unexamined Patent Publication No. 2011-0055990 (published on May 26, 2011, patent document 1) and Korean Registered Utility Model Publication No. 20-0440991 (registered on Jul. 8, 2008, patent document 2).

For example, patent document 1 discloses a photovoltaic power generation buoy, which uses a float member including a photovoltaic module (or solar cell) for power generation, a battery charged with generated power, a control circuit, a lamp unit, a frame for fixing the elements, and a case.

In addition, patent document 2, as shown in FIG. 1, discloses a danger indication apparatus of a vessel, in which a danger indication flag 100 is attached to a support flagpole 200, an elastic spring 300 is coupled to a lower end of the support flagpole 200, and a lower end of the elastic spring 300 is fastened to a fixing magnet 600 and a support case 500 by a fastening bolt 400. When the support case 500 is placed nearby a manhole of a block upon ship drying, the support flagpole 200 can be prevented from deviating from its position due to the magnetic force of the fixing magnet 600 even when a worker collides with the support flagpole 200 or strong wind blows, and the support flagpole 200 may move in the impact direction due to the elastic force of the elastic spring 300 so that the support flagpole 200 may be prevented from being broken.

### DISCLOSURE

### Technical Problem

However, the flag according to the related art had a problem in that the flag is not effective at night.

In particular, in case of the flag used in the ship, lighting has to illuminate onto the flag to make the flag recognizable at night, so the electric power of the ship is necessary. In addition, even when the lighting illuminates onto the flag, if the flag waves due to the wind at sea, the lighting may not sufficiently illuminate onto the flag, making it difficult to recognize the flag.

Further, in case of the flag used for business in the restaurant or the shop, a lighting device is required to allow customers to recognize the letter or figure displayed on the flag, causing excessive power consumption. In particular, in a season where great power consumption is caused, such an advertisement is restricted to reduce energy consumption.

The present invention has been made to solve the above problems and an objective of the present invention is to provide a flag apparatus which uses an optical fiber so that the letter or figure displayed on the flag in the ship, restaurant or shop can be easily recognized even at nighttime.

Another object of the present invention is to provide a flag apparatus which can minimize energy consumption for recognizing the letter or figure displayed on the flag.

### Technical Solution

In order to accomplish the above objectives, the present invention provides a flag apparatus which includes a supporting pole, a flag suspended from the supporting pole, an optical fiber thread having an exposure part which is formed by exposing a partial area or an entire area of a front surface of the flag and is configured in a letter or figure, and a power source module for radiating light or an image on the optical fiber thread, wherein the power source module includes a light source unit, a power supply unit for supplying electric power to the light source unit, and a control unit for controlling the light source unit and the power supply unit, and the exposure part is configured to be installed on the flag through at least one method among weaving, embroidery, sewing, laminating, and piping.

In the flag apparatus according to the present invention, the flag may be a national flag, a hoist flag, a triangular flag used for promoting a sport and an event or representing a milestone, a condolence flag, a shoulder girdle, a ship identification flag, and a flag for promoting business of a restaurant or a shop.

In the flag apparatus according to the present invention, a protective layer coated with a waterproof member may be provided on the exposure part.

In the flag apparatus according to the present invention, the power supply unit may include a solar cell panel, the power source module may be provided on the supporting pole, and the optical fiber thread may be accommodated in a connection member that connects the flag to the supporting pole.

In the flag apparatus according to the present invention, a reflective sheet may be provided at one side of the flag to reflect light generated from the exposure part.

In the flag apparatus according to the present invention, the exposure part may include a scratched surface which may be formed by heat-treating, laser-processing, eroding or cutting an outer surface of the optical fiber thread.

In the flag apparatus according to the present invention, the exposure part may include a core thread, the core thread may include one of a metallic fiber, a synthetic fiber and an animal fiber, the metallic fiber may be selected from a silver thread, a wire, a titanium thread, an aluminum thread, and a copper thread, the synthetic fiber may be selected from nylon, polyester and acryl, and the animal fiber may include silk or spider web.

In the flag apparatus according to the present invention, a synthetic resin layer may be coated on the optical fiber thread at a predetermined thickness.

### Advantageous Effects

As described above, according to the flag apparatus of the present invention, the flag placed in the ship, restaurant or shop can be easily recognized even at nighttime.

In addition, the flag apparatus according to the present invention uses solar energy, reducing fossil energy consumption.

### DESCRIPTION OF DRAWINGS

FIG. 1 is a view showing an example of use of a flag according to the related art.

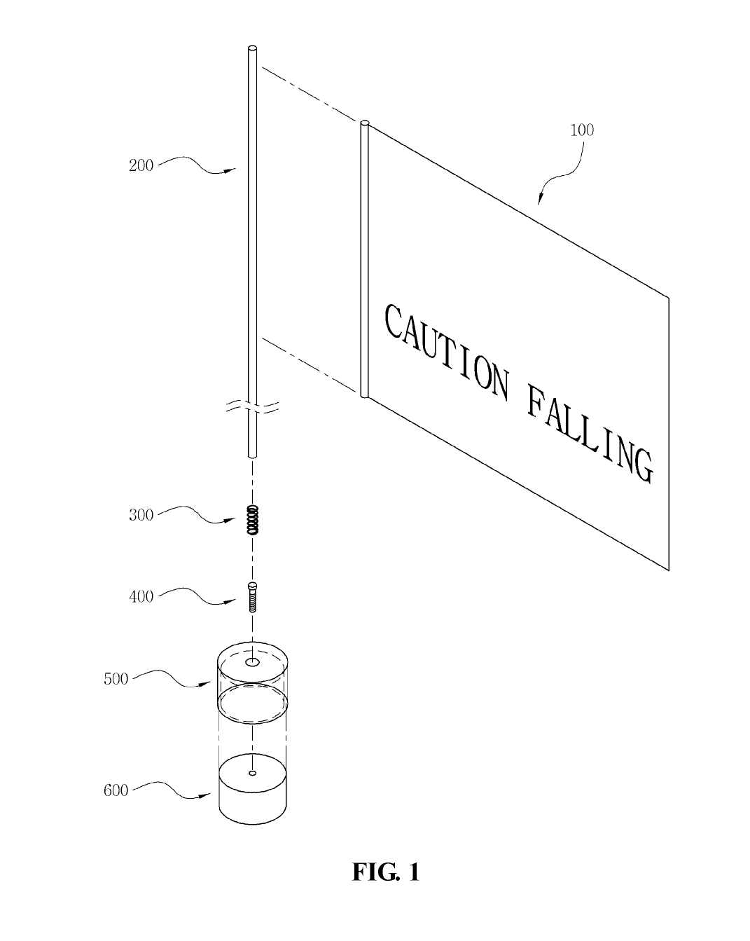

FIG. 2 is a block diagram showing a structure of a flag apparatus according to the present invention.

FIG. 3 is a view showing a flag apparatus according to the present invention, which is installed at a flagstaff or a flagpole of a government office, a local autonomy, a school, or a troop.

FIG. 4 is a view showing a reflective sheet mounted on a flag apparatus according to the present invention.

FIG. 5 is a view showing a flag apparatus according to the present invention, which is installed on a supporting pole for event promotion.

FIG. 6 is a view showing a flag apparatus according to the present invention, which is used as a flag in a restaurant or a shop.

FIG. 7 is a view showing a flag apparatus according to the present invention, which is installed on an XY banner support.

FIG. 8 is a view showing a flag apparatus according to the present invention, which is used as a ship identification flag.

FIG. 9 is a perspective view showing a water-resisting optical fiber thread used in a flag apparatus according to the present invention.

### BEST MODE

### Mode for Invention

The above and other objectives and features of the present invention will be more apparent from the description of the specification and the accompanying drawings.

The term ‘flag’ adopted in the present invention may include, as an example, “a national flag, a hoist flag, which is a symbol of a government office, a local autonomy, a school, or a troop, a triangular flag used for promoting an event or representing a milestone, a condolence flag, a shoulder girdle, a ship identification flag, and a flag for a restaurant or a shop”, but the present invention is not limited thereto. The flag may be selected from a fabric, a paper, a synthetic resin and a metallic sheet. In detail, the flag may be prepared by using one of a synthetic resin fiber, various clothes made from an animal fiber and a vegetable fiber, a wallpaper, a leather, a sheet, a synthetic resin film, a traditional Korean paper, a non-woven fabric, a sponge, a gold foil, a silver foil, a copper foil, a double-sided tape and a single-sided tape and the flag may be prepared from a material capable of displaying a letter or figure.

The term ‘weaving’ adopted in the present invention may signify that the flag is manufactured by mixed use of an optical fiber with a normal fiber.

The term ‘embroidery’ adopted in the present invention may signify that a letter or figure is embroidered on a planar fabric, cloth or vinyl by using an optical fiber.

The term ‘sewing’ adopted in the present invention may signify that an optical fiber is fixedly sewed on a planar fabric, cloth or vinyl.

The term ‘laminating’ adopted in the present invention may signify that an optical fiber is fixedly bonded on a surface of a planar fabric, cloth or vinyl by using an adhesive.

The term ‘piping’ adopted in the present invention may signify that a normal tape or a linear tape (base material) is placed on an edge of household items, such as shoes, caps, bags or various clothes made from a cloth, a leather or various synthetic resins, to prevent strands from being released and to neatly treat the sewing line or an end part, and the normal tape or the linear tape is rolled in the form of a pipe, and then various core materials are inserted into the pipe to fix and process the core materials through sewing or bonding or to extrude the core materials together with a synthetic resin and a luminescence fiber.

Hereinafter, the configuration of the present invention will be described with reference to accompanying drawings.

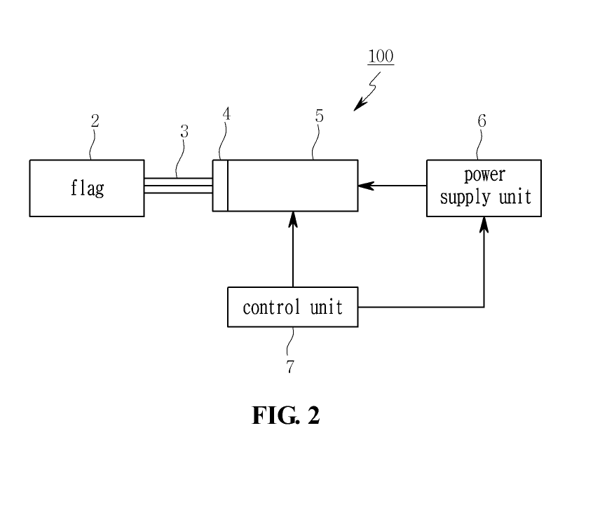

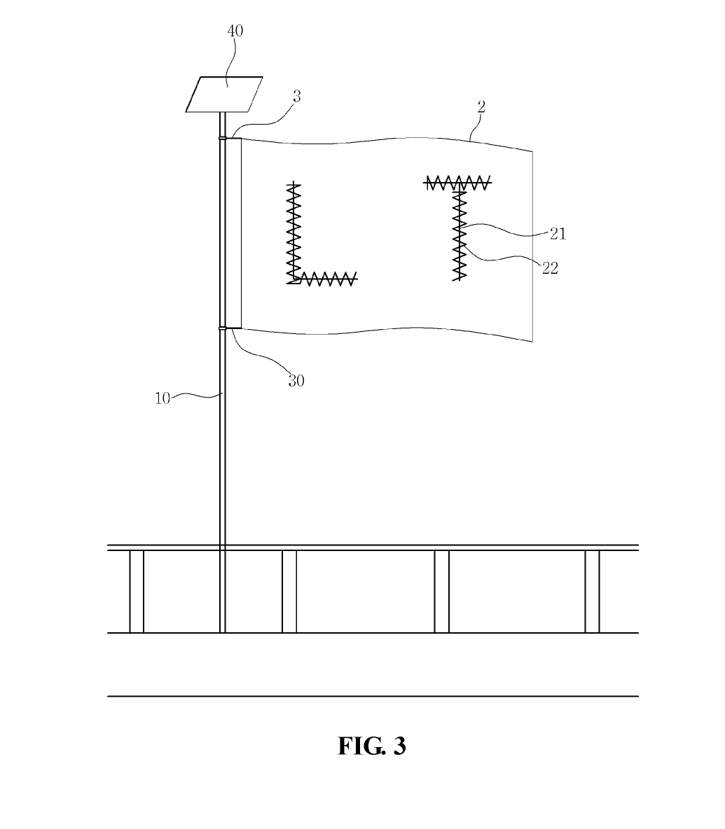

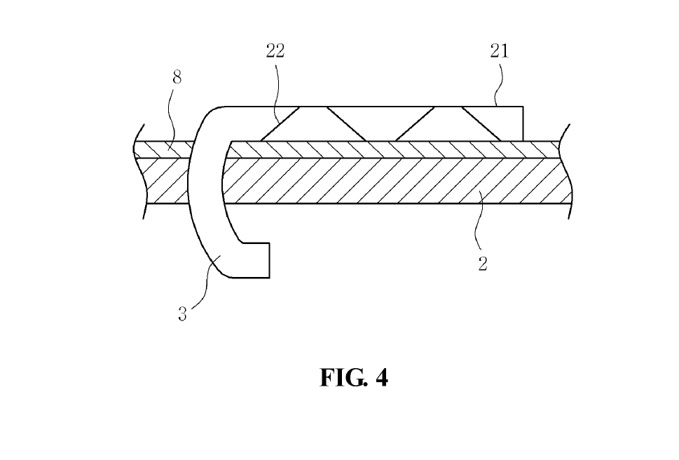

FIG. 2 is a block diagram showing a structure of a flag apparatus according to the present invention, FIG. 3 is a view showing the flag apparatus according to the present invention, which is installed at a flagstaff or a flagpole of a government office, a local autonomy, a school, or a troop, and FIG. 4 is a view showing a reflective sheet mounted on the flag apparatus according to the present invention.

As shown in FIGS. 2 and 3, the flag apparatus 100 using the optical fiber according to the present invention includes a flag 2 suspended from a supporting pole 10.

The flag apparatus 100 may include an optical fiber thread 3 having an exposure part 21 which is formed by exposing a partial area of a front surface of the flag 2 and is configured in a letter or figure, a bundle part 4 configured by binding rear ends of the optical fiber threads 3, a light source unit 5 for irradiating light or an image on the optical fiber thread 3 through the bundle part 4, a power supply unit 6 for supplying electric power to the light source unit 5, and a control unit 7 for controlling the light source unit 5 and the power supply unit 6.

Similar to the typical flag, the flag 2 may be prepared by using various clothes, which are woven by using a synthetic resin fiber, an animal fiber and a vegetable fiber, but the present invention is not limited thereto.

The power supply unit 6 may include a solar cell panel and the exposure part 21 is configured to be installed on the flag 2 through at least one method among weaving, embroidery, sewing, laminating, and piping. In addition, the flag 2 may be partitioned in the form of a lattice and a pattern of the exposure part 21 of the optical fiber thread 3 may be formed in each cell of the lattice.

As described above, since the power supply unit 6 includes the solar cell panel, the flag apparatus 100 may have a power source for light emission of the optical fiber thread 3. Thus, different from the related art, an additional power source for recognizing the letter or figure may not be required in the flag apparatus 100 so that the flag apparatus may be simply installed.

In order to improve the light emission performance of the optical fiber thread 3, it is preferred to bury a metallic core in the optical fiber thread 3. A light reflective part may be formed on a surface of the metallic core through erosion or plating to improve the light scattering.

In addition, in order to maximize the light emission area of the optical fiber thread 3, the exposure part 21 may have a wider width or the exposure part 21 may be pressed by using a heater (not shown) such that the exposure part 21 may have a wider planar area.

In addition, the flag 2 according to the present invention is one of a national flag, a hoist flag, a triangular flag used for promoting an event or representing a milestone, a condolence flag, a shoulder girdle, a ship identification flag, and a flag for promoting business of a restaurant or a shop and it is preferred to prepare the flag 2 by using a material having the same function as that of the conventional flag.

The optical fiber thread 3 is attached to the flag 2 in such a manner that the exposure part 21 of the optical fiber thread 3 can be exposed in various forms. For example, a scratched surface is formed on an outer surface of the exposure part 21 of the optical fiber thread 3 to allow light emission. The scratched surface is formed by scratching the outer surface of the outer surface of the exposure part 21. The scratched surface can be formed through sand blasting, erosion by etching, heat treating, or laser processing, which is generally known in the art, so the detailed description thereof will be omitted.

In addition, the exposure part 21 may be bonded by using an adhesive or may be fixed by sewing a thread.

That is, as shown in FIG. 3, the optical fiber thread 3, which is exposed through the front surface of the flag 2 in the form of letters “LT”, is temporally placed on the front surface of the flag 2 in the form of a specific letter or figure, and a thread 22 is sewed upon the optical fiber thread 3 (so called overlock) or bonded on the optical fiber thread 3 by using an adhesive, thereby forming the desired letter or figure.

In addition, the exposure part 21 is not limited to the shape mentioned above, but it may be variously modified.

Meanwhile, as shown in FIG. 3, the flag 2 is mounted on the supporting pole 10 through a connection member 30. A lower end of the connection member 30 may be a normal string integrally formed with the flag 2 and an upper end of the connection member 30 may be a string in which the optical fiber thread 3 is accommodated. That is, the optical fiber thread 3 according to the present invention is a flexible material and may have a function of the connection member 30 like a fiber.

In addition, referring to the structure shown in FIG. 3, the power supply unit 6 includes the solar cell panel and is provided at an upper portion of the supporting pole 10. The bundle part 4, the light source unit 5, the power supply unit 6 and the control unit 7 may constitute a power source module 40 as shown in FIG. 3.

In other words, the power source module 40 including the solar cell panel is provided at an upper portion of the supporting pole 10 and the optical fiber thread 3 is coupled to the power source module 40 through the bundle part 4. Such a coupling structure is disclosed in detail in Korean Unexamined Patent Publication No 10-2013-0077055 (published on Jul. 9, 2013) which is filed by the applicant of the present invention.

For example, rear ends of the optical fiber threads 3 are bound in the form of a bundle so that the bundle part 4 as shown in FIG. 2 may be formed. The bundle part 4 as shown in FIG. 2 may be divided into a plurality of bundle parts 4 by binding the rear ends of the optical fiber threads 3 in a unit of several strands. In this case, end portions of the bundle parts 4 are cut to have the same plane and then the end portions of the bundle parts 4 are bonded to each other by using an adhesive or a tape. The planar surface of the bundle parts serves as an image input surface and the light source unit 5 is closely attached to the image input surface to perform the light irradiation or image irradiation.

The light source unit 5 irradiates the light or the image onto the bundle part 4 and preferably has a function of an LED, a projector, an OLED advertisement board, a TV, an LCD TV, a PDP or a DMB.

Further, as shown in FIG. 2, the flag 2 according to the present invention preferably includes a reflective sheet 8.

The reflective sheet 8 has a function of reflecting light generated from the exposure part 21. According to the embodiment of the present invention, the reflective sheet 8 is prepared by using a PET (Polyethylene Terephthalate) film and silver or aluminum is preferably deposited on a surface of the PET film.

Since the flag 2 includes the reflective sheet 8, the light generated from the exposure part may be reflected in the forward direction so that the entire light emission efficiency of the flag apparatus 100 can be improved.

Meanwhile, in order to prevent the optical fiber thread 3 from being worn or damaged due to external friction and to prevent moisture penetration when the optical fiber thread 3 is exposed to the outside, a waterproof member, such as a resin, may be preferably coated on an outer surface of the exposure part 21 of the optical fiber thread 3 to form a protective layer.

Preferably, the resin preferably includes a transparent synthetic resin or a colored synthetic resin.

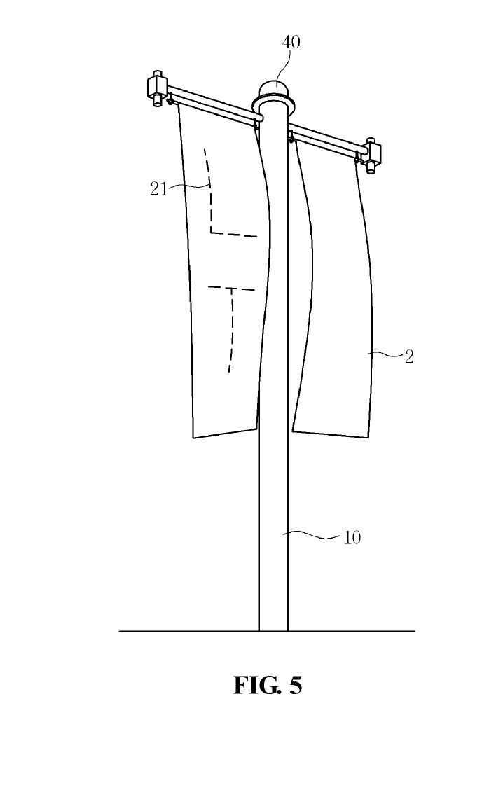

Hereinafter, an application example of the flag apparatus according to the present invention will be described with reference to FIGS. 5 to 7.

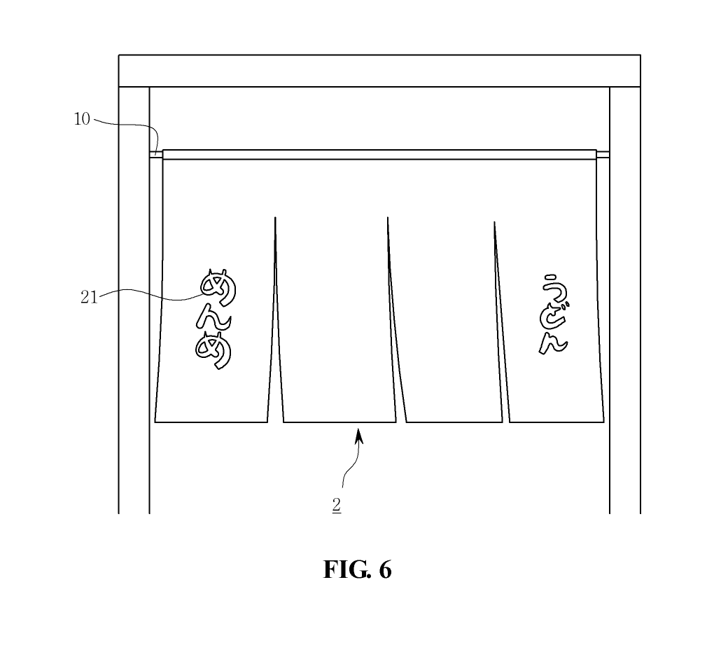

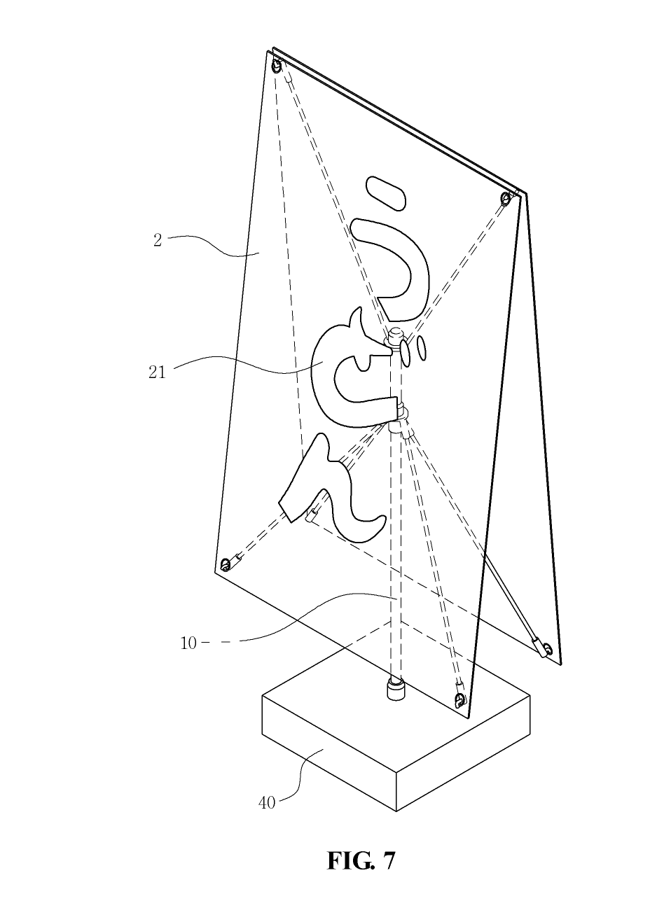

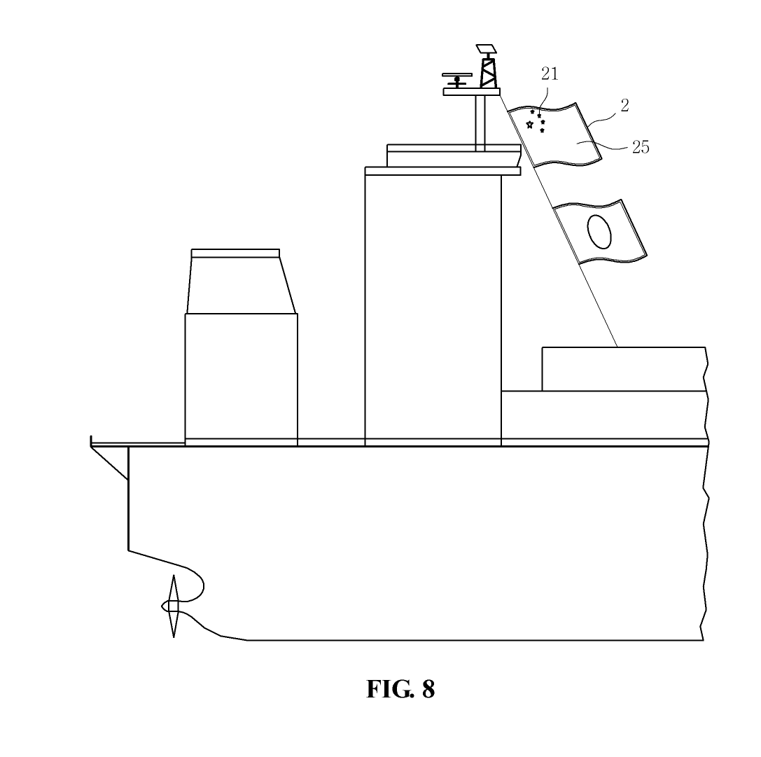

FIG. 5 is a view showing the flag apparatus according to the present invention, which is installed on the supporting pole for event promotion, FIG. 6 is a view showing the flag apparatus according to the present invention, which is used as a flag in a restaurant or a shop, FIG. 7 is a view showing the flag apparatus according to the present invention, which is installed on an XY banner support, and FIG. 8 is a view showing the flag apparatus according to the present invention, which is used as a ship identification flag.

As shown in FIG. 5, the exposure part 21 of the optical fiber thread 3 is sewed onto the flag 2 through a running stitch scheme such that the optical fiber thread 3 can be partially exposed.

Referring to the example shown in FIG. 5, the exposure part 21 of the optical fiber thread 3 is exposed in the form of lines having a predetermined length so that the light emission area can be expanded and the visibility can be improved. Meanwhile, in the structure shown in FIG. 5, the power source module 40 is provided at an upper portion of the supporting pole 10 so that the power source for light emission of the optical fiber thread may be prepared.

As described above, the flag apparatus 100 according to the present invention can be simply installed in a structure where a separate power supply line is not provided, and the flag having the letter or figure can be easily recognized at nighttime due to the light emission of the exposure part 21.

In addition, the configuration of the exposure part 21 is not limited to the above. When the flag 2 is manufactured, the letter or figure can be formed through weaving or the exposure part 21 of the optical fiber thread 3 may be laminated onto the letter or figure which is formed after the flag 2 is manufactured.

As shown in FIG. 6, the flag 2 can be adopted as a flag for a restaurant or a shop. That is, as shown in FIG. 6, the supporting pole 10 may be horizontally installed at an upper portion of an entrance door of the restaurant and a plurality of flags 2 having the letter or figure may be provided under the supporting pole 10.

In the structure shown in FIG. 6, for example, the power source module 40 can be readily implemented by providing the power source module 40 at the roof of the restaurant and guiding the optical fiber thread 3 through the supporting pole 10. In the case of letters shown in FIG. 6, one letter may be provided in one cell of the flag, or the letters may be prepared through the weaving, piping or embroidery according to the request of customers.

By providing the flag apparatus 100 shown in FIG. 6, the menu of the restaurant can be readily recognized even at nighttime without an additional lighting apparatus.

As shown in FIG. 7, the flag 2 according to the present invention can be applied to an XY banner support used on the road as a sign board.

In detail, when the flag apparatus 100 according to the present invention is applied to the XY banner support, a typical main pipe of the banner support may serve as the supporting pole 10, and the single-sided or double-sided flag 2 may be supported by the supporting pole 10, the exposure part 21 may be installed on the flag 2 through at least one method among weaving, embroidery, sewing, laminating, and piping, and a base provided at a lower portion of the banner support may serve as the power source module 40. Preferably, a battery is used as the power source module 40 shown in FIG. 7. However, the present invention is not limited to the above. For instance, a solar cell panel may be provided at an upper portion of the supporting pole 10.

Further, as shown in FIG. 8, the flag 2 according to the present invention may be used as a ship identification flag for representing the type, the country and the sailing status of the ship. That is, as shown in FIG. 8, for example, the flag can be installed to a control room provided at the uppermost part of the ship or a rope connected to the mast.

Meanwhile, in order to prevent the flag apparatus 100 from being contaminated by sea water when the flag apparatus 100 according to the present invention is applied to the ship, a protective layer 25 made from a waterproof material, such as vinyl, is preferably formed on the entire surface of the flag 2. In the structure as shown in FIG. 8, the power source module 40 may be provided at an upper portion of the control room.

Further, if the flag is installed at a specific position of the ship, such as a naval ensign or a naval jack, the structure of the flag apparatus 100 as shown in FIG. 3 may be adopted.

Meanwhile, when the flag apparatus 100 is used for the ship as shown in FIG. 8, it is preferred to provide the configuration as shown in FIG. 8 to prevent the optical fiber thread 3 from being eroded due to the exposure to the sea water.

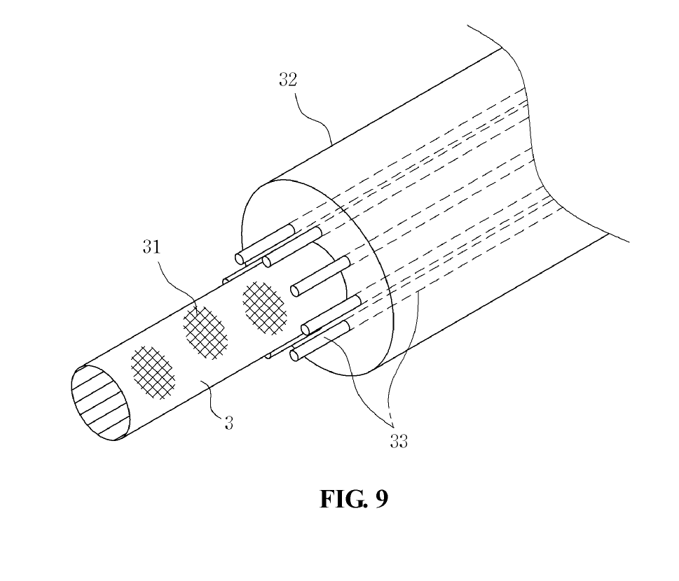

FIG. 9 is a perspective view showing a water-resisting optical fiber thread used in the flag apparatus according to the present invention.

As shown in FIG. 9, the water-resisting optical fiber thread is obtained by installing a core thread 33 in parallel to an outer surface of the optical fiber thread 3 and coating a synthetic resin 32 at a predetermined thickness. The synthetic resin 32 of at least one layer may be prepared and the synthetic resin 32 provided at the outermost layer may have a color.

In the configuration as shown in FIG. 9, a thickness of the synthetic resin layer formed by coating the synthetic resin 32, that is, a length from an outer surface of the optical fiber thread 3 to an outer surface of the synthetic resin 32 is about 8 to 10 microns, and a diameter of the core thread 33 is about 3 to 5 microns. Thus, the core thread 33 can be immersed in the synthetic resin 32 without being exposed to the outside.

Preferably, the core thread 33 described above may be selected from a metallic fiber, a synthetic fiber and an animal fiber, the metallic fiber may be a silver thread, a wire, a titanium thread, an aluminum thread, or a copper thread, the synthetic fiber may be nylon, polyester or acryl, and the animal fiber may be silk or spider web.

Although a preferred embodiment of the present invention has been described, the present invention is not limited thereto, and various modifications are possible without departing from the scope of the present invention.

In detail, although the embodiment is made based on the configuration where power generated from the solar cell plane of the power supply unit is supplied to the light source unit, the present invention is not limited thereto and a battery may be used when the flag of the present invention is used for a specific period of time.

In addition, although the core thread 33 is disposed in parallel to the outer surface of the optical fiber thread 3 in the configuration shown in FIG. 9, the present invention is not limited thereto and the core thread 33 may be wound in the form of coil and the synthetic resin 32 may be coated at a predetermined thickness.

### INDUSTRIAL APPLICABILITY

By using the flag apparatus according to the present invention, the letter or figure displayed on the flag of the ship, the restaurant or the shop can be clearly recognized even at nighttime.

1. A flag apparatus comprising:
a supporting pole;
a flag suspended from the supporting pole;
an optical fiber thread having an exposure part which is formed by exposing a partial area or an entire area of a front surface of the flag and is configured in a letter or figure; and
a power source module for irradiating light or an image on the optical fiber thread,
wherein the power source module includes a light source unit, a power supply unit for supplying electric power to the light source unit, and a control unit for controlling the light source unit and the power supply unit, and
the exposure part is configured to be installed on the flag through at least one method among weaving, embroidery, sewing, laminating, and piping.

2. The flag apparatus of claim 1, wherein the flag includes one of a national flag, a hoist flag, a triangular flag used for promoting a sport and an event or representing a milestone, a condolence flag, a shoulder girdle, a ship identification flag, and a flag for promoting business of a restaurant or a shop.

3. The flag apparatus of claim 1, wherein a protective layer coated with a waterproof member is provided on the exposure part.

4. The flag apparatus of claim 1, wherein the power supply unit includes a solar cell panel, the power source module is provided on the supporting pole, and the optical fiber thread is accommodated in a connection member that connects the flag to the supporting pole.

5. The flag apparatus of claim 1, wherein a reflective sheet is provided at one side of the flag to reflect light generated from the exposure part.

6. The flag apparatus of claim 1, wherein the exposure part includes a scratched surface which is formed by heat-treating, laser-processing, eroding or cutting an outer surface of the optical fiber thread.

7. The flag apparatus of claim 2, wherein the exposure part includes a core thread, the core thread includes one of a metallic fiber, a synthetic fiber and an animal fiber; the metallic fiber is selected from a silver thread, a wire, a titanium thread, an aluminum thread, and a copper thread; the synthetic fiber is selected from nylon, polyester and acryl; and the animal fiber includes silk or spider web.

8. The flag apparatus of claim 1, wherein a synthetic resin layer is coated on the optical fiber thread with a predetermined thickness.
